(19) United States
(12) Patent Application Publication
(10) Pub. No.: US 2004/0243383 A1
(43) Pub. Date: Dec. 2, 2004

(54) System and method for making complex electronic circuits

(76) Inventors: Pierangelo Garino, Torino (IT); Fabio Ricciato, Torino (IT); Alfredo Ruscitto, Torino (IT); Maura Turolla, Torino (IT); Antonio Varriale, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/485,998

(22) PCT Filed: Jul. 9, 2002
(86) PCT No.: PCT/IT02/00450

(30) Foreign Application Priority Data
Jul. 10, 2001 (IT) TO01A000667
Aug. 7, 2001 (IT) TO01A000794

(51) Int. Cl. G06F 9/455

(52) U.S. Cl. 703/23

(57) ABSTRACT

The present invention relates to a system (10) and method for making electronic circuits comprising elements or elementary circuit blocks which can be implemented either in the form of physical circuits, for instance FPGA, or in the form of firmware, for instance memorised on microprocessor. Thanks to the methodology used to describe the circuit blocks (26a, 26b) and their functional models (21), the system (10) and method allow to execute with a WS (11) and an emulator subsystem (30), in a single integrated environment, both the functional simulation of the model of complex electronic circuit and the emulation of the electronic circuit itself. Moreover, thanks to the characteristics of intrinsic congruence between the circuit blocks (26a, 26b) and their models (21), the emulation of the complex electronic circuit can be effected using alternatively circuit blocks implemented on the emulator subsystem either in the form of hardware (26a) or in the form of firmware (26b).

### TECHNICAL FIELD

The present invention relates to a system and method for making complex electronic circuits, for instance complex integrated circuits or SOC (System On Chip), which, as is well known, comprise both physical circuit elements (hardware) and processing programs (firmware or software) able to implement determined functions of the complex circuit.

In particular the present invention relates to a system and method for designing and testing complex electronic circuits in which hardware and software combined and integrated together allow to perform complex electronic functions, such as the management, in telecommunication apparatuses, of transmission and reception information streams.

### BACKGROUND ART

As is well known, complex electronic circuits (complex circuits) are designed by combining together elementary blocks, for instance extracted from a library, and implementing such blocks either in the form of physical circuit elements, in which case the term used is hardware Intellectual Property (hardware IP), or in the form of program circuit elements, in which case the term used is software IP.

In particular, the making of such complex circuits requires, according to the prior art, a sequence of steps which can be described as follows:

a functional description step 110 (FIG. 1) of the complex circuit; in said step 110, starting from specifications 100 relating to the circuit to be obtained, a functional description of the circuit is generated by a system designer, for instance by means of a high level programming language such as the C language;

a functional simulation step 120 of the circuit described in the step 110, in which the operation of the circuit is verified, regardless of its actual implementation with physical elements (hardware blocks) or programme elements (software or firmware blocks);

a so-called partitioning step 130 of the complex circuit, in which the system designer, based on his/her experience, identifies both the blocks to be implemented as physical or hardware blocks and the blocks to be implemented as software blocks; hence, given the partitioning 130, the design of the electronic circuit bifurcates into

a description step 140a, for instance by means of a VHDL language (Very high speed integrated circuit Hardware Description Language) in general such as to allow to obtain the hardware blocks by synthesis, and a step 150a of actually obtaining said hardware blocks, for instance in the form of programmable FPGA (Field Programmable Gate Array) logic; and

a step 140b whereby the software blocks are described and a step 150b whereby they are made, for instance in the form of firmware for a determined processor; naturally, in the steps 140a and 140b, the IP libraries, respectively hardware 145a and software 145b, are used if available, in order to expedite the design steps for said blocks; once the hardware and software development steps are complete, the design is completed by

a step 160 whereby the complex circuit or a prototype thereof is tested in which, using appropriate known testing devices, the hardware blocks 150a and the firmware blocks 150b are assembled and tested.

The sequence of steps described herein, however, especially when the partitioning step is not trivial, has a plurality of problems.

A first problem consists of the fact that, if in the testing step 160 problems linked to the partitioning of the circuit emerge and hence said step needs to be repeated, it becomes necessary to repeat, in accordance with the prior art, the description step (140a or 140b) and realisation step (150a or 150b) for the involved blocks with considerable time and energy expenditure.

This is because any modification introduced in the partitioning requires the replacement of the hardware blocks with corresponding software blocks or vice versa.

Said operation, as is well known, is not trivial since each block, even if it belongs to an IP library, must be adapted to the design specifications and it must be iteratively tested to verify its exact correspondence with the block it replaces.

A second technical problem of the prior art consists of the fact that, subsequently to the partitioning, the system designer relinquishes control over the development and realisation steps, in particular for the hardware blocks, and hence only in the testing step he is able to verify whether what has been obtained does in fact correctly comply with design specifications.

In fact, the development and construction of the hardware blocks in particular, requires specific skills relating to the generation and simulation of architectural models of the hardware, skills which, as is well known, are not typically those of the system designer whose skills are instead related to the writing of software and function blocks.

### DISCLOSURE OF THE INVENTION

The aim of the present invention is to describe a system and a method for making complex circuits wherein any variations in the partitioning of the circuit itself do not entail the repetition of the development and realisation phases that are typical of the prior art.

An aim of the present invention is also a system and a method wherein the system designer constantly maintains, during the development and realisation phases, control over such phases based on his/her own specific skills.

Yet another aim of the present invention is a system and method that allows to simulate and test complex circuits in a manner that is transparent to the apparatuses used for the execution of said phases.

The aim is achieved by the system and method for making complex electronic circuits as described in the claims.

In particular, the aim is achieved by the system and method, according to the present invention, wherein the elementary blocks of the complex circuit or the IP library have as their essential characteristics that of being “neutral”, in the sense that they can be used both to represent hardware blocks (physical elements) and software blocks (programme elements).

Thanks to said characteristic, the partitioning phase of the prior art is not a critical any longer, since any hardware or software block can be dynamically replaced by a corresponding alternative software or hardware block, without entailing the repetition of the development and realisation phase.

Moreover, in accordance with a further characteristic of the present invention, the elementary blocks of the complex circuits or the IP library, being “neutral”, can be used both during the initial design phases to conduct the functional simulation and during the testing phases, consequently allowing to reduce the number of phases necessary to obtain said complex circuits.

### BRIEF DESCRIPTION OF DRAWINGS

This and other characteristics of the present invention shall become readily apparent from the following description of a preferred embodiment, provided by way of non limiting example with the aid of the accompanying drawings, in which:

FIG. 1 shows a flow chart of the method for obtaining complex electronic circuit according to the prior art;

FIG. 2 shows a block diagram of the system according to the invention;

FIG. 3 shows an example of transmission chain whereto the method according to the invention can be applied; and

FIG. 4 shows a flow chart of the method according to the invention.

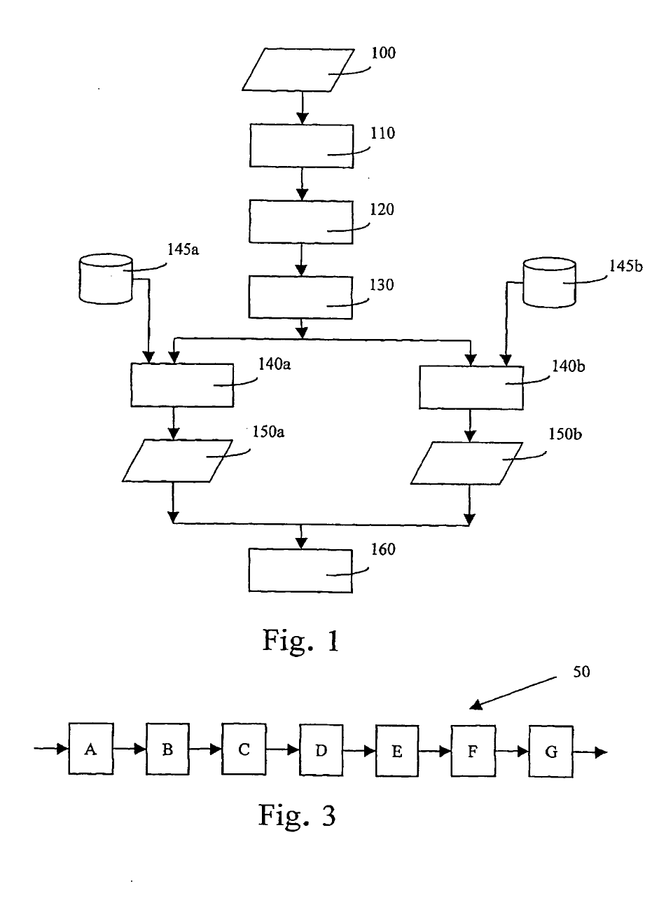

### BEST MODE FOR CARRYING OUT THE INVENTION

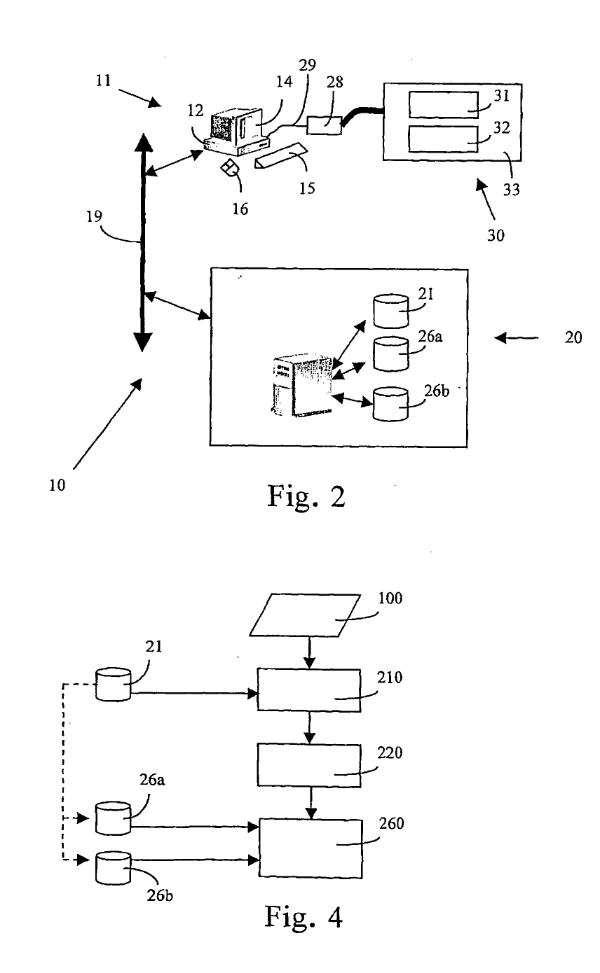

With reference to FIG. 2, a system 10 for making complex electronic circuits (complex circuits) comprises, for example, a computerised work station (WS) 11, of a known kind, having a processor subsystem (base module) 12, a display device (display) 14, a keyboard 15, a pointing device (mouse) 16 and a device for connection to a local area network (network connection) 19.

The Work Station 10, for instance the model J5000 by Hewlett-Packard having a 450 MHz CPU with 1 Gbyte RAM, an 18 Gbyte hard disk drive and a UNIX operating system, is able to process software programs or modules and to display their results on the display 14, as shall be described in detail hereafter with reference to the method according to the invention.

The system 10 further comprises a known subsystem of disks 20, connected by means of the network connection 19 to the WS 11 and able to store software modules and reference libraries implemented for the execution of the method according to the invention, as shall be described in detail hereafter.

Naturally, the software modules and the libraries can also be stored, if their size is limited, in the hard disk drive of the WS 11 without thereby changing the characteristics of the invention.

The system 10 also comprises an emulator subsystem or testing device 30 connected, for example, to the WS 11 by means of a parallel connection (connection) 29 and a JTAG (Joint Test Action Group) interface 28, known in themselves. The known testing device 30 is able to emulate the behaviour of the complex electronic circuit, as shall be described in detail hereafter, and it is constituted, for instance, by an ARM INTEGRATOR/AP board 33 by ARM Corp., comprising a first module (μP module) 31, for instance an ARM INTEGRATOR/CM module with ARM7TDMI microprocessor, and a second module (FPGA module) 32, for instance an ARM INTEGRATOR/LM module having an FPGA programmable logic.

The system 10, in the configuration described above, is able to allow the realisation and testing of complex electronic circuits or of corresponding prototypes in accordance with the present invention, as shall be described in detail hereafter.

Moreover, the system 10 by means of the software programs and reference libraries, stored, for example, in the RAM, allows the execution of the method according to the invention.

In general, the software programs and reference libraries according to the invention can be delivered in many forms, including, but not limited to: information permanently stored on non-writable storage media and information alterably stored on writable storage media.

The example of implementation of the system and method according to the invention is described referring to a transmission chain 50 (FIG. 3) comprising the following function blocks:

A: data entering block;

B: turbo encoder block;

C: BPSK (Binary Phase Shift Keying) modulator block or BPSK modulator;

D: Gaussian white noise generator channel (channel);

E: BPSK demodulator block (BPSK demodulator);

F: turbo decoder block and

G: data extraction block.

The blocks A, B, C, E, F and G are representative, for instance, of physical circuit elements (hardware) or processing programmes (programme circuit elements or firmware) of a complex circuit to be realised, and the block D is representative of a transmission channel subject to noise.

Naturally, for the realisation of the system and method according to the present invention any chain of function blocks able to process information and/or data can be taken as reference, as shall become readily apparent to a person versed in the art on the basis of the description that follows.

Thus, taking the chain 50 as reference, the method according to the present invention comprises a first functional description step (description) 210 (FIG. 2, FIG. 3, FIG. 4) of the complex circuit in which, given the specifications 100, the function blocks of the complex circuit to be realised are described for instance by means of a C programming language, for example the blocks A through C of the chain 50.

In accordance with a first characteristic criterion of the present invention, the description 210 must be executed in such a way that to each of the block that corresponds to hardware or firmware circuit elements is associated a corresponding single model in the selected programming language.

In accordance with a second characteristic criterion of the present invention, the description 210 of each block must be executed in such a way that internal functions to the block, depending on the physical characteristics of the μP module 31 available on the testing device 30, are written independently from said type of μP module 31.

In particular, all functions that may depend on the architecture of the microprocessor present on the μP module 31 are described, in accordance with the present invention, in code lines that are external (external packages) to the model representing the involved circuit element.

Subsequently, during the testing step, depending on the selected microprocessor, a corresponding specific support file for the microprocessor present on the μP module 31 will be used.

For example, the READ/WRITE functions of each function block, when using in accordance with the present embodiment a μP 31 module with ARM7TDMI microprocessor have, for instance, a form of the following type:

```
//### READ/WRITE FUNCTIONS USED IN THE FUNCTION
BLOCKS###
extern void word_write(int addr, int data);
extern int word_read(int addr);
//### END ###
//### EXTERNAL SPECIFIC PACKAGE FOR ARM7TDMI ###
word_write
    STMFD SP!,{lr} ; save return address to stack
    STR r1,[r0,#0] ; store data r1 in r0
    LDMFD SP!,{pc} ; return
word_read
    STMFD SP!,{r1,lr} ; save ret. addr. and r1 to stack
    LDR r1,[r0,#0] ; load temp with data
    MOV r0, r1 ; copy temp to r0 for return value
    LDMFD SP!,{r1,pc} ; return
//### END ###
```

Thanks to this characteristic, the code of each function block is of the “neutral” type since the specific parts of the microprocessor whereon the circuit is to be implemented are described on external packages.

Consequently, as will be readily apparent to a person versed in the art, the external packages can be optimised, for instance, on each occasion without changing the characteristics of the function blocks.

Moreover each function block can be used and simulated, being “neutral”, on computers with diversified operating systems, for instance on personal computers (PC) or on work stations (WS) with Windows/NT operating system.

In accordance with a third characteristic criterion of the present invention, the description 210 of each block must be carried out in such a way that any complex mathematical functions such as multiplications and divisions are implemented, when possible, in the selected programming language, by means of low level logic operations such as shifts and external masks.

Take for instance the following functions:

$$i = \frac{j * {2}^{q}}{16}$$

This function could be implemented in C language in the following way:

i=(J*Pow(2,q))/16;

in accordance with the aforesaid characteristics, such a function must be implemented by means of a form of the following kind:

i=(j<<q)>>4;

in which the complex mathematical functions are replaced by “shift” logic functions.

When this is not possible, external masks or functions must be used such as divide( ), multiply( ) which, in accordance with the second criterion described above, are optimised according to the microprocessor in use.

Thanks to said characteristic, the code of each function block is “neutral” in relation to mathematical functions and, therefore, it becomes possible to implement, without modifications, the code itself on microprocessors of various types and levels.

Moreover, as will be readily apparent to a person versed in the art, such a writing mode allows to generate, for instance in VHDL language, hardware circuit elements equivalent to the software elements.

In accordance with a fourth characteristic criterion of the present invention, the description 210 of each function block must be executed in such a way that the programming code allows to represent numeric values on a number of bits determined at will (binary field or vector) and to address a bit or a group of bits in any position within the field thus determined.

To achieve this end, in accordance with the present embodiment, a reference data structure is realised to represent the binary fields.

For instance, using the C language and applying the described method, three examples of data structures able to be used to index bit strings without using multiplications and divisions are provided below in Tab.1, Tab.2 and Tab.3 respectively:

TABLE 1

```
// Data type function
V_BIT GetBit(V_BYTE vector, long index)
{
    int ByteIndex;
    char BitIndex;
    ByteIndex = index >> 3;
    BitIndex = (index & 7);
    return (V_BIT) ((vector[ByteIndex] >> BitIndex) & 1);
}
```

The function of Tab.1, as will be readily apparent to a person versed in the art, allows to extract a bit (defined by the index position) from a vector of the V_BYTE type using low level functions of the C language.

```
TABLE 2
//Data type function
V_BIT SetBit(V_BYTE vector, long index, int value)
{
    int ByteIndex;
    char BitIndex;
    ByteIndex = index >> 3;
    BitIndex = (index & 7);
    if(value)
        vector[ByteIndex] = vector[ByteIndex] | (1 << BitIndex);
    else
        vector[ByteIndex] = vector[ByteIndex] &  ˜(1 <<
BitIndex);
    return value;
}
```

The function of Tab.2 allows to assign a value to any bit (defined by the index position) in a vector of the V_BYTE type using low level functions of the C language.

Through the realisation of data structures of the type described in Tab.1 and Tab.2, it is thus possible to describe the function blocks with low level C code, easily implemented, without modifications, on microprocessors of various kinds and levels.

TABLE 3

//Data type function
V_VBYTE create_VBYTE(V_LONG size)
{
return = (V_VBYTE) malloc(sizeof(V_BYTE) * size);
}

The function in Tab.3 allows to allocate in the memory a vector of dimensions expressed by “size”, as will be readily apparent to the person versed in the art.

An example is provided below, in which the functions of Tab.1, Tab.2 and Tab.3 are used to set, in a determined 150 Byte field, the 120^{th} bit to 1.

//### EXAMPLE OF USE ####
V_VBYTE data;
V_BIT result;
data = create_VBYTE(150);
SetBit(data, 120, 1);
result = GetBit(data, 120);

The data types V_VBYTE, V_BIT and the functions SetBit and GetBit are, as is readily understood, defined in the aforementioned external package.

Naturally, as will be readily apparent to a person versed in the art, such a writing mode also allows easily to generate hardware circuit blocks that are equivalent to the software blocks.

Thanks to this characteristic, the code of each function block is able both to manage, contrary to what is usual in the prior art, binary fields whose length can be varied at will and to examine or set the value of individual bits in any position.

Therefore, the description 210, for instance of the blocks of the chain 50, if executed following the four criteria set out above, allows to obtain function blocks that meet with the requirement of:

being “neutral”, in the sense that they can be implemented, with the same code, on any microprocessor; and

having a description that can easily be transferred into a circuit synthesis language, such as VHDL.

In accordance with an additional characteristic element of the present invention, the description of the individual function block and of any sub-blocks thereof must be executed in such a way as to separate the description of the functionality of the block or sub-block from the interface towards the other blocks or sub-blocks.

Using this technique it is possible to obtain a code, for instance a C language, that is easily exportable from the simulation environment to the testing environment, as shall be described in detail hereafter.

For instance, each block or sub-block of the chain 50 shall be described in such a way as to keep separate the part relating to the specific functions of the various blocks or sub-blocks, for instance by means of a description in C code, from the interface or “wrapper” part, for instance by means of a description in C++ code.

The block B of the chain 50 can be described, for instance, as shown below in Tab.4.

```
// WRAPPER START
class TurboEnc
{
    V_WORD RSC1, RSC2;
    V_INT FRAME;
    //...
    public:
    //...
    Run(V_BYTE, V_BYTE);
    ...
}
// WRAPPER END
```

in which the commented lines of the “// . . . ” type are representative of code lines to be personalised according to requirements, as will be readily apparent to a person versed in the art; and

```
TABLE 4
//FUNCTION BLOCK START
V_VBYTE TurboEnc::Run(V_VBYTE mem_in, V_VBYTE mem_out)
{
  V_INT i;
  V_BIT U, IU, C1, C2, rsc1_0, rsc2_0;
V_WORD termin[6];
// Turbo Encoder: frame
  for(i = 0; i < FRAME; i++)
    {
      rsc1_0 = (U=GetBit(mem_in, i)) \hat{ } ((RSC1 >> 1) % 2) \hat{ }
((RSC1 >> 2) % 2);
      C1 = rsc1_0 \hat{ } (RSC1 % 2) \hat{ } ((RSC1 >> 2) % 2);
      RSC1 = (RSC1 << 1) | rsc1_0;
      rsc2_0 = GetBit(mem_in, ivector[i]) \hat{ } ((RSC2 >> 1) % 2) \hat{ }
((RSC2 >> 2) % 2);
      C2 = rsc2_0 \hat{ } (RSC2 % 2) \hat{ } ((RSC2 >> 2) % 2);
      RSC2 = (RSC2 << 1) | rsc2_0;
    // Pack and Write code on mem_out
    word_mem_out = U | (C1 << 3) | (C2 << 6);
    word_write(mem_out + (i << 2), word_mem_out);
    }
  // Initialize terminations
  for(i = 0; i < 6; i++)
  termin[i] = 0;
  // Turbo Encoder: terminations
  for(i = 0; i < 3; i++)
    {
      U = ((RSC1 >> 1) % 2) \hat{ } ((RSC1 >> 2) % 2);
      IU = ((RSC2 >> 1) % 2) \hat{ } ((RSC2 >> 2) % 2);
      rsc1_0 = false;
      C1 = rsc1_0 \hat{ } (RSC1 % 2) \hat{ } ((RSC1 >> 2) % 2);
      RSC1 = (RSC1 << 1) | rsc1_0;
      rsc2_0 = false;
      C2 = rsc2_0 \hat{ } (RSC2 % 2) \hat{ } ((RSC2 >> 2) % 2);
      RSC2 = (RSC2 << 1) | rsc2_0;
    // Pack terminations on mem_out
    termin[i] = U | (C1 << 3);
    termin[i + 3] = IU | (C2 << 6);
    }
  // Write terminations on mem_out
  for(i = 0; i < 6; i++)
  word_write(mem_out + FRAME + (i << 2), termin[i]);
  return mem_out;
}
// FUNCTION BLOCK END
```

Using the technique shown in the example of Tab.4, it is thus possible to extrapolate the functionality of the block and make it “neutral” with respect to the interface.

In other words, a function is to be transformed into a method of a class.

In so doing, as a person versed in the art will readily understand, the class becomes the object, i.e. the function block, and its interface can be modified as well as the chain to be realised varies, leaving the functionality of the block itself unaltered.

Using this fifth description criterion, it is thus possible generate a description of function blocks and sub-blocks that are both easy to interface in diversified context and able to allow an easy extrapolation of the part to be implemented on software or hardware.

Naturally, all criteria described above can also be applied to the generation of a library of function blocks (function library) 21, for instance associated to the disk sub-system 20, in such a way that given the specifications 100, the description step 210 uses, if available, blocks having the described “neutrality” characteristics, drawn from the function block library 21.

Once the description 210 is complete, the complex circuit can be functionally simulated in the simulation step 220 to verify compliance with design specifications.

Said step 220 is substantially equivalent to the simulation step 120 of the prior art and can be conducted with processing tools available on the market, residing in WS 11, controlling and modifying, by means of the keyboard 15 and the mouse 16, configuration parameters of the complex circuit to be realised until obtaining results that comply with the specifications 100.

Naturally, thanks to the “neutrality” characteristics described above, the simulation may be executed on work stations with diversified operating system.

The simulation 220 is able to provide, for instance, by visualisation on the display 14 of the WS 11, both input data to the block A and output data from the block G, in such a way as to allow, for instance, their comparison with the input data.

The simulation step, in accordance with the present embodiment, is followed by a test step 260, additional characteristic element of the present invention.

Said step 260 is activated and controlled by the WS 11 by means of the connection 29 to the testing device 30 and it comprises the following elementary steps.

Initially the system designer identifies, within the complex circuit to be obtained, the elements to be implemented in the form of physical circuit blocks (hardware blocks) or of program circuit blocks (firmware blocks) and, according to this initial choice, he associates to each circuit block a corresponding and equivalent hardware or firmware model.

The hardware models, for instance described in VHDL language, can be part of a hardware library IP 26a whose equivalency with the corresponding blocks of the function block library 21 has been verified.

This verification of equivalency between hardware models or blocks and function models or blocks, requires, for example, the application of further rules or criteria for the functional and hardware (architectural) description which can be summarised as follows.

First rule: The functional description of function blocks must be performed in such a way that each function block can be replaced by corresponding and equivalent hardware (circuit) blocks during the corresponding architectural description step.

Second rule: The functional description of the function model and the corresponding architectural description must be parametric in order to be specialised, as parameters vary, with no need to compile the various functional or architectural blocks.

Third rule: The functional description of the function model must use precision data that are equivalent to those of the hardware description, once the description of the individual function blocks is complete.

In summary, the equivalence between function models of the function block library 21 and hardware models of the hardware library IP 26a can be obtained, for example, not only by assuring the scalability of the sub-modules (first description rule) and using the same parameters (second description rule), but also using, for the function models, types of data that allow a strict control over precision (third description rule).

Naturally, the coding of the function blocks according to the characteristic criteria of the present invention could facilitate and simplify, in addition to the above three rules, the coding of hardware models equivalent to the function blocks.

The firmware models, for instance described in C language, can be part of a software library IP 26b whose equivalency with the function library 21 is substantially immediate based on the characteristic criteria of the present invention.

Said firmware models correspond, with the exception of the “wrapper” part that is specific of the functional simulation, to the code generated in the description step 210.

As soon as the circuit blocks are associated to corresponding hardware and firmware models, the system designer can generate with the WS 11 what is necessary for testing the complex circuit.

In particular, on the basis of the hardware and firmware models the system designer is able to generate, by synthesis, the hardware part and, by compilation, the firmware part and to transfer them onto the testing device 30, respectively on the FPGA module 32 and on the UP module 31.

After completing said steps, it is thus possible to test the complex circuit and verify its actual behaviour.

If the behaviour of the complex circuit fails to meet expectations or the system designer wants to verify alternative solutions, thanks to the characteristics of the present invention it is possible to replace, by means of the WS 11 and during the testing step 260 itself, the hardware models of the library 26a with firmware models 26b and/or vice versa with no need to repeat the description step 210 and functional simulation step 220 or any additional description and simulation steps.

As will be readily understood by a person versed in the art, the hardware and firmware models are, based on the criteria indicated above, intrinsically equivalent to the function blocks or models.

Moreover, the replacement in the testing step on the μP module 31 of one type of microprocessor with an alternative type does not force to repeat the description step 210 and simulation step 220, since, thanks to the “neutrality” of said steps with respect to the microprocessor change, the compilation of the firmware depends only on the compiler used and not on the written code.

Taking as reference the chain 50, which relates to a circuit for coding and decoding concatenated convolutional codes (turbo codes), the method according to the present invention is implemented as follows.

In the description step 210, based on the specifications 100, the chain 50 is realised, for instance, drawing the blocks or modules A through G from the function library 21. Among the modules A through G, only the module D is not representative of a circuit block.

After completing the description step assigning to the various function blocks specific scenario parameters corresponding to the complex circuit to be realised, the functional simulation 220 is activated on the WS 11.

During the functional simulation 220, by means of the WS 11 the behaviour of the chain 50 is simulated, by simulating that the module A draws from the disk unit of the WS 11, for instance, an image captured with a television camera, and transfers it into the encoder B; the coded image passes through the modulator BPSK C, undergoes the addition of channel additive Gaussian noise with the block D, is demodulated by the module E until reaching the decoder F which decodes the image, reconstructs and transfers it to the module G which for example stores it in the disk drive of the WS 11 in such a way as to allow to compare the resulting image with the transmitted image, showing the two images on the display 14.

The functional simulation 220 allows to display the corrective effect of the turbo decoder F in the presence of Gaussian noise and to dimension according to the required performance or specifications 100 some critical parameters of the turbo decoder F, as is readily apparent to the person versed in the art.

Moreover, the functional simulation 220 allows to characterise the turbo decoder F obtaining BER (Bit Error Rate) curves as the noise or SNR (Signal Noise Ratio) of the channel D varies.

After completing the functional simulation 220 and defining the scenario of parameters to be associated to the turbo coding and decoding circuit to be obtained, the testing step 260 is started.

For instance, in a first step all blocks A through C and E through G are implemented in firmware, according to the programming criteria described above, and stored on the μP module 31 of the testing device 30.

The test 260, in this case, is necessarily equivalent to the simulation conducted on the WS 11 with the sole difference of using a particular microprocessor and hence of being able to highlight any differences linked to the characteristics of the microprocessor itself.

In this testing step 260, naturally, it will also be possible to display and compare the resulting image and the one transmitted on the display 14 of the WS 11.

The testing step 260, for instance, if the actual behaviour is not satisfactory, can at this point be repeated replacing, by means of the keyboard 15 or the mouse 16 (input devices) of the WS 11, the firmware module corresponding to the turbo decoder F with the equivalent hardware module, i.e. the equivalent version in VHDL language, for instance drawn from the hardware library IP 26a.

In this case, the compilation of the VHDL module is effected by synthesis and for instance, either a Full Custom integrated circuit or, as in the present case, a code for “configuring” the FPGA component present on the FPGA module 31 of the board 33 is generated.

In this case too, thanks to the present invention, the operation of the chain 50 will be identical to the previous one, but in regard to performance it will be possible, for instance, to obtain and verify very different results in terms of speed.

In essence, the ability to replace firmware (software) modules with equivalent hardware modules, as described, makes the partitioning of the complex circuit a step that is substantially similar to and can be incorporated into the testing step 260.

Although the replacement of a firmware block with a hardware block, as in the example, requires the introduction of an additional dialogue interface between the microprocessor of the μP module 32 and the turbo decoder of the FPGA module 31, as will be readily apparent to a person versed in the art, nonetheless the ability to make the replacement will allow to avoid repeating the steps of describing and verifying the individual blocks of the chain 50 or of the complex circuit to be realised, as is typical of the prior art.

Obvious modifications or variations are possible to the above description, in dimensions, shapes, materials, components, circuit elements, connections and contacts, as well as in the details of the circuitry and of the construction illustrated and of the method of operation without thereby departing from the scope of the invention as specified by the claims that follow.

1. Method for making complex electronic circuits comprising a plurality of blocks (A-G) representative of circuit elements and wherein at least one block of said plurality of blocks can be implemented on said complex electronic circuit by means of physical circuit elements (hardware blocks) or, alternatively, by means of program circuit elements (firmware blocks), comprising the steps of:
describing (210) a model of said complex electronic circuit comprising at least one model of block corresponding to said at least one block of said plurality of blocks (A-G);
simulating (220) said model of complex electronic circuit in accordance with predefined specifications; and
emulating (260) the behaviour of the complex electronic circuit corresponding to said model of complex electronic circuit selectively assigning to said at least one model of block a corresponding physical (26a) or programme circuit element (26b).

2. Method as claimed in claim 1, wherein the step of describing a model (210) of a complex electronic circuit comprises the step of:
associating to each of said blocks a corresponding single block block functional model.

3. Method as claimed in claim 1 wherein said step of emulating (260) the behaviour of the complex electronic circuit comprises the step of:
replacing said model of block described by means of a determined description language (C) with an equivalent physical or programme circuit element.

4. Method as claimed in claim 3 wherein
said equivalent programme circuit element is described with said determined description language (C) and is substantially identical to said model of block.

5. Method as claimed in claim 3 wherein
said model of block belongs to a library of circuit models; and wherein
said equivalent physical circuit element belongs to a library of physical circuit elements; and
said equivalent programme circuit elements belongs to a library of programme circuit elements described with said determined description language (C).

6. Computer products loadable in an internal memory of an electronic computer for implementing the method as claimed in claim 1.

7. System for making complex electronic circuits comprising a plurality of blocks (A-G) representative of circuit elements and wherein at least one block of said plurality of blocks (A-G) can be implemented on said complex electronic circuit by means of physical circuit elements (hardware blocks) or, alternatively, by means of programme circuit elements (firmware blocks), characterised by:
a processor subsystem (12) able to process and simulate in accordance with predefined specifications a model of said complex electronic circuit comprising at least one model of block corresponding to said at least one block of said plurality of blocks; and by:
an emulation subsystem (30) connected to said processor subsystem (12) and able to emulate the behaviour of the complex electronic circuit corresponding to said model of complex electronic circuit selectively assigning to said at least one model of block a corresponding physical (26a) or programme circuit element (26b) implemented on said emulation subsystem (30).

8. System as claimed in claim 7 characterised in that said processor subsystem (12) comprises an input device (15, 16) able to control said emulation subsystem (30) to emulate said complex electronic circuit using alternatively said physical circuit elements (26a) or said programme circuit elements (26b).

9. System as claimed in claim 7 characterised in that said processor subsystem (12) is associated to a library of models of circuit elements (21) and in that said emulation subsystem {30) is associated to a library of physical circuit elements (26a) and of programme circuit elements (26b) equivalent to said models of circuit elements.

10. System as claimed in claim 9, characterised in that the blocks of said library of programme circuit elements (26b) are substantially identical to said block models of said library of circuit models (21).
